(19) United States
(12) Patent Application Publication
(10) Pub. No.: US 2012/0180183 A1
(43) Pub. Date: Jul. 19, 2012

(54) HIGH IMPACT SHIN PROTECTOR

(76) Inventors: Chris Mechling, San Diego, CA (US); Nick Mechling, San Diego, CA (US)

(21) Appl. No.: 13/352,605

(22) Filed: Jan. 18, 2012

Related U.S. Application Data
(60) Provisional application No. 61/433,841, filed on Jan. 18, 2011.

(51) Int. Cl. A41D 13/06; B23P 11/00

(52) U.S. Cl. 2/22; 29/428

(57) ABSTRACT

A protective article, comprising: a shin section extending downward from a knee area to an ankle area of an individual; and a foot section extending outward from an ankle area to a toe area of the individual, covering the top of the individual's foot, wherein the shin section contains an interior removable insert and at least two pair of straps, wherein a first strap pair is positioned below the knee area and a second strap pair is positioned above the ankle area, with a first attachment point for the first and second pair of straps on one lateral edge of the shin section and a second attachment point for the first and second pair of straps on the opposite lateral edge of the shin section.

### CROSS REFERENCES

This application claims priority from U.S. Provisional Application No. 61/433,841 filed Jan. 18, 2011, the contents of which are incorporated by reference herein.

### FIELD OF THE INVENTION

This invention relates generally to the field of protective articles for the leg/foot region of an individual and, more particularly, to protective articles for use in high-impact activities, such as those associated with martial arts.

### BACKGROUND OF THE INVENTION

The legs are one of the most exposed areas of the body during contact sport activities, such as soccer, baseball or martial arts. In particular, the shin region of the leg is greatly exposed during high impact activities and, thus, requires a great deal of protection.

The prior art is replete with examples of shin guards or shin protectors for use in high impact activities having high degrees of forces that have the potential of causing damage to individuals. Most of the devices in the prior art consist of a pad that is bound to the lower leg of an individual by a strap that extends around the diameter of the lower leg and either attached by hook-and-loop to the front or back of the shin guard. Some devices attempt to provide coverage toward the distal region of the lower leg and out onto the foot. These are typically the standard equipment for a baseball player at the catcher position.

One of the major disadvantages of any form of leg protection made out of any high density material is that it often results in an uncomfortable fit, where the individual engaged in the contact sport must sacrifice comfort for safety. Further, because of the lack of a breathability component associated with the material, the user is often subjected to a great deal of perspiration due to the fit of the protective apparatus. This results in a high rate of slippage of the protective elements, defeating the whole purpose of the safety wear.

U.S. Pat. No. 5,613,250 to Bell was an early attempt at providing protection for an individual using lawn and garden equipment from debris coming back and hitting the user's leg. This leg guard provided leg, ankle and foot apparel protection which was meant to protect the shoe top and shoestrings from flying debris from string trimmers, lawn mowers, and the like. While this may have been useful for mowing lawns, this prior art device would be incompatible in the realm of martial arts or a similar high impact activity with the potential for bodily harm in the leg region.

U.S. Pat. No. 6,560,781 to Keene et al. discloses a very specific type of specialized equipment for a catcher in baseball. The protection is all focused around the upper, middle and lower knee region, and additional extending all of the way down to cover the entire foot. It is meant to be worn on top of clothing and cleats. It is attached by way of a series of straps and clips. This protection cannot be utilized for protection in martial arts, particularly because of the bulky composition of the material, as well as the relatively inflexible nature of the equipment.

U.S. Patent Publication No. US 2008/0120756 filed by Shepherd discloses a leg protection article for use in contact sports. The disclosure points to the desire of having the leg protection extend down over the foot and even accommodating a toe to be inserted through a loop to keep the dorsal foot protection in place. This is disadvantageous in the field of contact sports, such as martial arts, due to the high probability of an injury occurring because of the strap around the toe of the user. Furthermore, the disclosure is silent with respect to solving the problem in the art of having the interior portion of the shin protector being able to withstand the build-up of perspiration, which impacts the value of the protection device. Furthermore, the straps around the calf region are also subjected to high degrees of perspiration and water, therefore leading to slippage and a twisting of the protective device.

U.S. Patent Publication No. 2009/0276943 filed by Balolia exemplifies yet another embodiment within this field. In this disclosure, an impact assembly is disclosed as a unified system, wherein a great number of parts are connected through sections and connecting chains. Once fully assembled, the device affords layers of protection for the user. However, the principle behind this disclosure is to function as an impact dispersion system. The invention of Balolia is impractical for use in contact sports such as martial arts or soccer, where comfort, flexibility and function are of utmost priority. Further, there is no accommodation for identifying a means of resolving the problems associated with perspiration or water saturating the protective device.

U.S. Patent Publication No. 2011/0289663 filed by Kamradt discloses protective equipment for use in protective, exclusively, the shin of an individual. The disclosure goes to great detail in an effort to identify the surface portion of the guard having a ribbed appearance. However, this protection device does not extend to the foot, h is also silent with respect to any benefit achieved in using the device for full-contact martial arts or sparring exercises associated with same.

Thus, there exists a need in the art to solve the shortcomings identified above and provide an improved shin protector capable of provide maximum comfort, flexibility and protection while serving to attend to the problems with perspiration and device attachment issues related to same.

### SUMMARY OF THE INVENTION

The present invention provides for a protective article, comprising: a shin section extending downward from a knee area to an ankle area of an individual; and a foot section extending outward from an ankle area to a toe area of the individual, covering the top of the individual's foot, wherein the shin section contains a removable insert, positioned in the interior space of the shin section, and at least two pairs of straps, wherein a first strap pair is positioned below the knee area and a second strap pair is positioned above the ankle area, with a first attachment point for the first and second pair of straps on one lateral edge of the shin section and a second attachment point for the first and second pair of straps on the opposite lateral edge of the shin section, further wherein the foot section extends outward from the shin section at about a 90 degree angle, the foot section having a unified strap extending from one lateral medial edge to the other lateral medial edge and an ankle strap at the rear of the foot section.

One object of the present invention provides for the shin section and the foot section being composed of high density, closed cell foam material selected from the group consisting of ethylene vinyl acetate, polyethylene, polystyrene, neoprene and rubber-based composites. Preferably, the shin section extends laterally to cover the individual's lateral calf region and the foot section extends downwardly to cover the individual's foot region.

A further embodiment of the present invention provides for the interior removable insert within the shin section being absorbent and washable.

In another embodiment, the shin section is connected to the foot section by means of a fabric connector.

In yet another embodiment, the first strap pair and the second strap pair are composed of rubber or composite thereof, further wherein the rubber or composite thereof is applied in strips or channels to the interior surface of the first strap pair and the second strap pair. Alternatively, the first strap pair and the second strap pair are integrated into the shin section.

Another object of the present invention provides for a method of manufacturing a protective article comprising: providing a shin section capable of extending downward from a knee area to an ankle area of an individual, wherein the shin section comprises at least two pairs of straps, further wherein a first strap pair is positioned below the knee area and a second strap pair is positioned above the ankle area, with a first attachment point for the first and second pair of straps on one lateral edge of the shin section and a second attachment point for the first and second pair of straps on the opposite lateral edge of the shin section; providing a foot section capable of extending outward from an ankle area to a toe area of the individual, covering the top of the individual's foot; attaching a fabric connector in order to connect the shin section to the foot section; wherein the shin section contains an interior removable insert, further wherein the foot section extends outward from the shin section at about a 90 degree angle, the foot section having a unified strap extending from one lateral medial edge to the other lateral medial edge of the foot section and an ankle strap at the rear of the foot section.

In a preferred embodiment, the method provides for the shin section and the foot section being composed of high density, closed cell foam material selected from the group consisting of ethylene vinyl acetate, polyethylene, polystyrene, neoprene and rubber-based composites. More preferably, the method provides for the shin section extending laterally to cover an individual's lateral calf region.

An additional embodiment of the present invention provides for a removable insert, positioned in the interior space of the shin section being attached to the shin section by a means selected from the group consisting of hook-and-loop, elastic lining, laces, buckles and snaps. Preferably, the interior removable insert is absorbent and washable

In yet another embodiment, the method of the present invention further includes providing the first strap pair and the second strap pair integrated into the shin section. Preferably, the first strap and the second strap are composed of rubber or composite thereof, further wherein the rubber or composite thereof is applied in strips or channels to the interior surface of the first strap and the second strap.

Further objects and advantages of the present invention will be apparent from the following description of the preferred embodiments when considered in conjunction with the accompanying drawings.

### BRIEF DESCRIPTION OF THE DRAWINGS

FIG. 1 is a front view of the protective article of the present invention with the straps laid open;

FIG. 2 is a side view of the protective article of the present invention;

FIG. 3 is top perspective view of the protective article of present invention with the straps in a closed position;

FIG. 4 is a rear perspective view of the protective article of the present invention depicting a removable insert;

FIG. 5 is a top view of the protective article of the present invention;

FIG. 6 is a lateral cross-sectional view of the protective article of the present invention showing the hook portion of the hook-and-loop fastener embodiment associated with the first and second pair of straps.

Similar reference characters denote corresponding features consistently throughout the attached drawings.

### DETAILED DESCRIPTION OF THE INVENTION

Compositions according to the present invention comprise a shin protector capable of withstanding high impact, high three collisions as a result of contact sports due to the construction and materials used. For example, the type of materials utilized in the construction of the shin protector of the present invention is composed of high density, closed cell foam material selected from the group consisting of ethylene vinyl acetate (EVA), polyethylene, polystyrene, neoprene and rubber-based composites. This is a substantial improvement over the shin guards described in the prior art.

EVA foam has been used extensively across a variety of industries, from sporting goods to photovoltaic cell construction. As foam, it is known for its shock-absorbing qualities. A preferred object of the present invention is to provide a shin protector which will provide an improvement over the prior art in terms of shock-absorbing features, durability and improved attachment ability to the user.

In an additional aspect of the present invention, the shin protector of the present invention will provide a means of spreading out the force of the high-impact, high-force activities associated with contact sports by having a relatively dense layer of foam material, combined with extending the lateral sides of the shin guard to disperse the force applied at the surface. In one embodiment, the protective article of the present invention provides for a durable construction which is able to accommodate the high forces observed in full contact martial arts activities. Preferably, there will be multiple layers of foam material, each with varying densities, which will further enable the protective article to better spread the force of impact laterally across the shin section, thereby reducing the chances of injury to the user.

Compositions according to the present invention further include a protective article, comprising: a shin section extending downward from a knee area to an ankle area of an individual; and a foot section extending outward from an ankle area to a toe area of the individual, covering the top of the individual's foot, wherein the shin section contains a removable insert, positioned in the interior space of the shin section, and at least two pairs of straps, wherein a first strap pair is positioned below the knee area and a second strap pair is positioned above the ankle area, with a first attachment point for the first and second pair of straps on one lateral edge of the shin section and a second attachment point for the first and second pair of straps on the opposite lateral edge of the shin section, further wherein the foot section extends outward from the shin section at about a 90 degree angle, the foot section having a unified strap extending from one lateral medial edge to the other lateral medial edge of the foot section and an ankle strap at the rear of the foot section.

Preferably, the shin section and the foot section are composed of high density, closed cell foam material selected from the group consisting of ethylene vinyl acetate, polyethylene, polystyrene, neoprene and rubber-based composites. These sections may have a unified layer of foam material. Optionally, there may be multiple layers of the above mentioned closed-cell foam materials utilized in the present invention.

Compositions according to the present invention further include a pre-treatment of any section of the protective article with antibacterial, antifungal, antimicrobial or germicidal compositions. Such compositions may be applied at any time during the manufacturing process (or post-manufacturing). The application of these various compositions will provide an improved hygiene element to the protective article and will greatly reduce the potential for infections and improve the hygiene element otherwise lacking in the shin guards of the prior art.

Compositions according to the present invention further include a removable insert that is located in the curved, interior space of the protective article. Preferably, a hook-and-loop fastener is used, wherein the hook fastener portion is a strip that spans the length of the lateral exterior face of the removable insert, with a counterpart loop fastener portion in the form of a complementary strip located along the length of the lateral interior edge of the shin section. More preferably, the removable insert will be absorbent and washable, capable of being easily removed and reattached by the user. The interior removable insert may also be attached to the shin section by a means selected from the group consisting of hook-and-loop, elastic lining, laces, buckles and snaps.

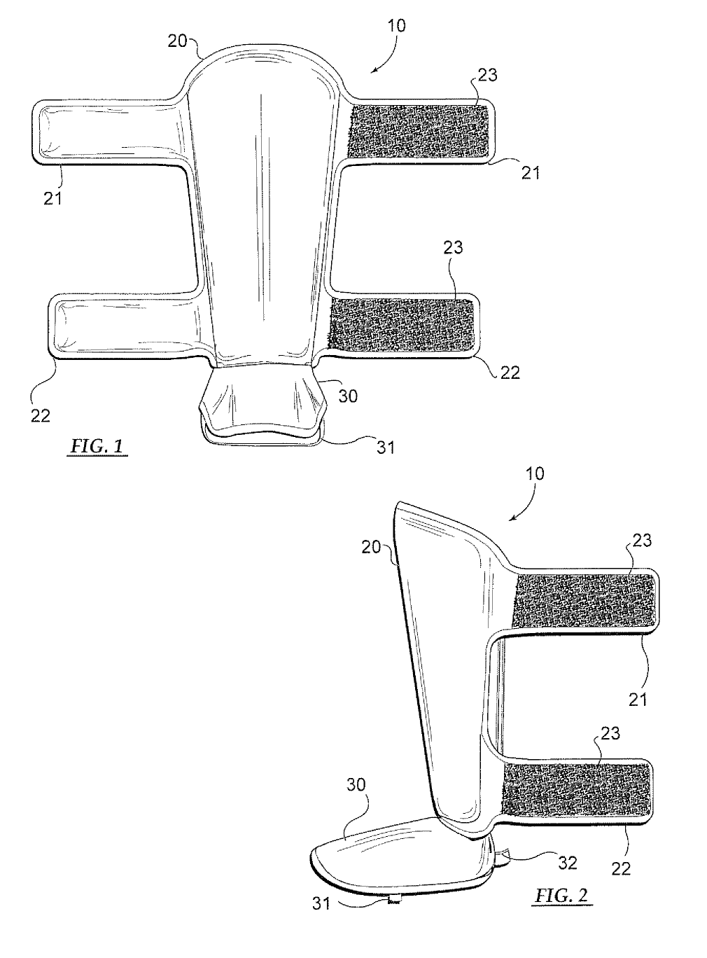

As detailed in FIG. 1, the shin protector 10 is comprised of a shin section 20 and a foot section 30. The shin section 20 has a first pair of straps 21 comprising a loop fastener portion 23 and a second pair of straps 22 comprising the loop fastener portion 23. The first pair of straps 21 wrap around the back of the leg, with the loop fastener portion 23 located on one member of the first pair of straps 2i connecting with the hook fastener portion (not shown) located on the other member of the first pair of straps 21. Similarly, the second pair of straps 22 wrap around the back of the leg, with the loop fastener portion 23 located on one member of the first pair of straps 22 connecting with the hook fastener portion (not shown) located on the other member of the first pair of straps 22. The foot section 30 has a unified strap 31 extending from one lateral medial edge of the foot section to the other lateral medial edge of the foot section.

With regard to FIG. 2, the shin protector 10 is comprised of the shin section 20 and the foot section 30. One strap each from the first pair of straps 21 and the second pair of straps 22 is shown, including the loop fastener portion 23 of the hook-and-loop fastener system associated with the first pair of straps 21 and second pair of straps 22 is also depicted. The foot section 30 has a unified strap 31 extending from one lateral medial edge of the foot section to the other lateral medial edge of the foot section. Additionally, an ankle strap 32 is present at the rear of the foot section 30. The unified strap 31 and the ankle strap 32 combine to form a solid fit with the user when engaging in contact sports described herewith.

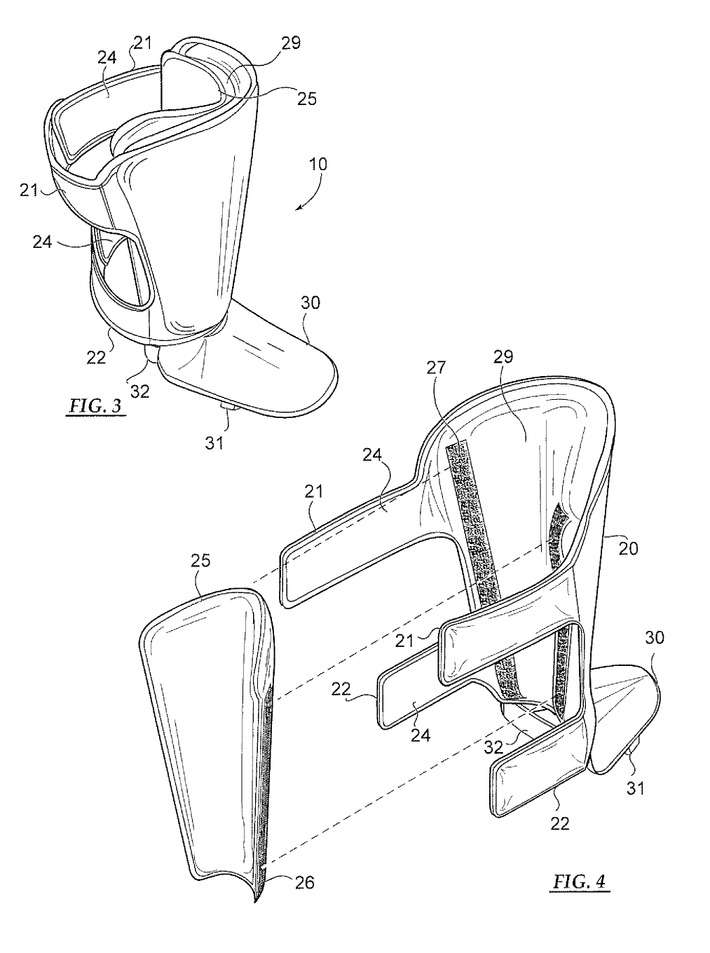

As further detailed in FIG. 3, the shin protector 10 functions optimally as a protective article once the first pair of straps 21 are fastened to one another and the second pair of straps 22 are fastened to one another. In a preferred embodiment, the interior surface 24 on both the first pair of straps 21 and second pair of straps 22 is lined with strips or channels of rubber or rubber composite to both improve the comfort to the user and to preclude the shin protector 10 from slippage out of optimal position due to the aggregation of perspiration, water or the like on the skin on the back of the leg of the user. A removable insert 25 is positioned within the interior space 29 of the shin section 20 and is attached by means of a fastener.

With regard to FIG. 4, the removable insert 25 is able to be attached and detached with ease as a result of the specific fastener used. As depicted here, the removable insert 25 has a hook fastener portion 26 in the form of a strip that spans the length of the lateral exterior face. A loop fastener portion 27 in the form of a complementary strip is located along the length of the lateral interior space 29 within the shin section 20. Optionally, the hook-and-loop components may be reversed, such that the hook fastener portion may be located in the interior space 29 of the shin section 20 with the corresponding loop fastener portion located on the exterior face of the removable insert 25 (not shown) so long as the each strip has the corresponding counterpart in the appropriate location.

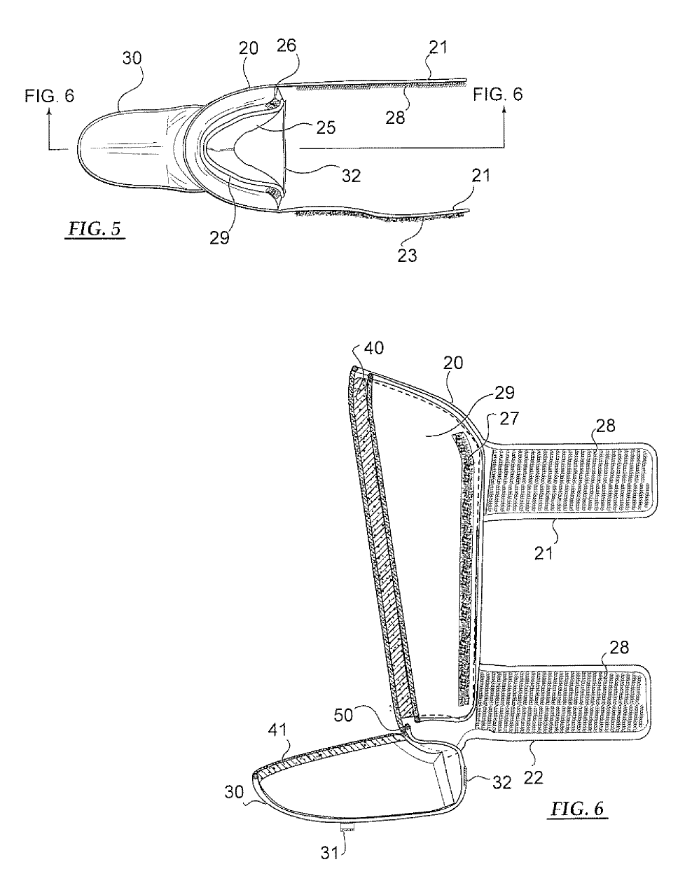

With regard to FIG. 5, the relationship between the first pair of straps 21 is observed. For attachment purposes, the strap within the first pair of straps 21 containing the loop fastener portion 23 is folded over first such that the interior surface 24 containing the rubber is pulled against the rear leg of a user, while the other strap within the first pair of straps 21 containing the hook fastener portion 28 if folded over the first strap such that the hook fastener portion 28 comes into contact with the loop fastener portion 23, thereby forming a tight connection.

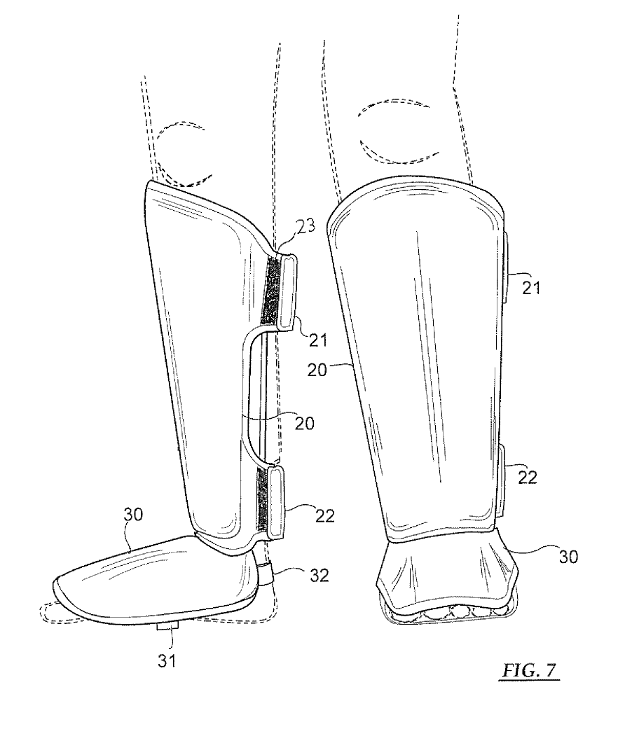

As described in FIG. 6, the cross sectional view depicts the internal foam materials 40 (within the shin section) and 41 (within the foot section). The internal foam materials 40, 41 can be made of a single layer, or multiple layers, with either equal or differing densities with respect to one another. Optionally, a fabric connector 50 is present at the interface between the shin section 20 and the foot section 30 in order to provide additional flexibility.

In FIG. 7, the shin protector 10 is shown fully attached to a user's legs. The first pair of straps 21 and second pair of straps 22 are depicted in bound form to the specified region on the back of the leg of the user. Also shown is the preferably zone on the foot and ankle for the unified strap 31 and the ankle strap 32, respectively.

As used in this specification and in the appended claims, the singular forms include the plural forms. For example the terms “a,” “an,” and “the” include plural references unless the content clearly dictates otherwise. Additionally, the term “at least” preceding a series of elements is to be understood as referring to every element in the series. The inventions illustratively described herein can suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the future shown and described or any portion thereof, and it is recognized that various modifications are possible within the scope of the invention claimed. Thus, it should be understood that although the present invention has been specifically disclosed by preferred embodiments and optional features, modification and variation of the inventions herein disclosed can be resorted by those skilled in the art, and that such modifications and variations are considered to be within the scope of the inventions disclosed herein. The inventions have been described broadly and generically herein. Each of the narrower species and subgeneric groupings falling within the scope of the generic disclosure also form part of these inventions. This includes the generic description of each invention with a proviso or negative limitation removing any subject matter from the genus, regardless of whether or not the excised materials specifically resided therein. In addition, where features or aspects of an invention are described in terms of the Markush group, those schooled in the art will recognize that the invention is also thereby described in terms of any individual member or subgroup of members of the Markush group. It is also to be understood that the above description is intended to be illustrative and not restrictive. Many embodiments will be apparent to those in the art upon reviewing the above description. The scope of the invention should therefore be determined not with reference to the above description, but should instead be determined with reference to the appended claims, along with the full scope of equivalents to which such claims are entitled. Those skilled in the art will recognize, or will be able to ascertain using no more than routine experimentation, many equivalents to the specific embodiments of the invention described. Such equivalents are intended to be encompassed by the following claims.

What is claimed is:

1. A protective article, comprising:
(a) a shin section extending downward from a knee area to an ankle area of an individual; and
(b) a foot section extending outward from an ankle area to a toe area of the individual, covering the top of the individual's foot,
wherein the shin section contains a removable insert, positioned in the interior space of the shin section and at least two pairs of straps, wherein a first strap pair is positioned below the knee area and a second strap pair is positioned above the ankle area, with a first attachment point for the first and second pair of straps on one lateral edge of the shin section and a second attachment point for the first and second pair of straps on the opposite lateral edge of the shin section, further wherein the foot section extends outward from the shin section at about a 90 degree angle, the foot section having a unified strap extending from one lateral medial edge to the other lateral medial edge of the foot section and an ankle strap at the rear of the foot section.

2. The article according to claim 1, wherein the shin section and the foot section are composed of high density, closed cell foam material selected from the group consisting of ethylene vinyl acetate, polyethylene, polystyrene, neoprene and rubber-based composites.

3. The article according to claim 1, wherein the shin section extends laterally to cover the individual's lateral calf region and the foot section extends downwardly to cover the individual's lateral foot region.

4. The article according to claim 1, wherein the interior removable insert is attached to the shin section by a means selected from the group consisting of hook-and-loop, elastic lining, laces, buckles and snaps.

5. The article according to claim 1, wherein the interior removable insert is absorbent and washable.

6. The article according to claim 1, wherein the shin section is connected to the foot section by means of a fabric connector.

7. The article according to claim 1, wherein the first strap pair and the second strap pair are integrated into the shin section.

8. The article according to claim 1, wherein the first strap pair and the second strap pair are composed of rubber or composite thereof, further wherein the rubber or composite thereof is applied in strips or channels to the interior surface of the first strap pair and the second strap pair.

9. A method of manufacturing a protective article comprising:
(a) providing a shin section capable of extending downward from a knee area to an ankle area of an individual, wherein the shin section comprises at least two pairs of straps, further wherein a first strap pair is positioned below the knee area and a second strap pair is positioned above the ankle area, with a first attachment point for the first and second pair of straps on one lateral edge of the shin section and a second attachment point for the first and second pair of straps on the opposite lateral edge of the shin section;
(b) providing a foot section capable of extending outward from an ankle area to a toe area of the individual, covering the top of the individual's foot;
(c) attaching a fabric connector in order to connect the shin section to the foot section;
wherein the shin section contains a removable insert, positioned in the interior space of the shin section, further wherein the foot section extends outward from the shin section at about a 90 degree angle, the foot section having a unified strap extending from one lateral medial edge to the other lateral medial edge of the foot section and an ankle strap at the rear of the foot section.

10. The method according to claim 9, wherein the shin section and the foot section are composed of high density, closed cell foam material selected from the group consisting of ethylene vinyl acetate, polyethylene, polystyrene, neoprene and rubber-based composites.

11. The method according to claim 9, wherein the shin section extends laterally to cover an individual's lateral calf region.

12. The method according to claim 9, wherein the interior removable insert is attached to the shin section by a means selected from the group consisting of hook-and-loop, elastic lining, laces, buckles and snaps.

13. The method according to claim 9, wherein the interior removable insert is absorbent and washable.

14. The method according to claim 9, wherein the shin section is connected to the foot section by means of a fabric connector.

15. The method according to claim 9, wherein the first strap pair and the second strap pair are integrated into the shin section.

16. The method according to claim 9, wherein the first strap pair and the second strap pair are composed of rubber or composite thereof, further wherein the rubber or composite thereof is applied in strips or channels to the interior surface of the first strap pair and the second strap pair.
